(19) United States
(12) Patent Application Publication
(10) Pub. No.: US 2026/0367921 A1
(43) Pub. Date: Nov. 19, 2026

(54) SYSTEMS AND METHODS FOR SOFTWARE-ASSISTED LOAD VALUE PREDICTION

(71) Applicant: Huawei Technologies Co., Ltd., Shenzhen (CN)

(72) Inventors: Chuning Li, Markham (CA); Henry Fangli Kao, Markham (CA); Maziar Goudarzi, Markham (CA); Reza Azimi, Markham (CA)

(21) Appl. No.: 19/207,050

(22) Filed: May 13, 2025

(51) Int. Cl. G06F 9/38; G06F 8/41; G06F 9/30

(52) U.S. Cl. CPC G06F 9/3832; G06F 8/4441; G06F 9/30181

(57) ABSTRACT

A method for load value prediction at a first processor is provided. The method includes receiving executable code; processing the executable code to identify instructions having substantially stable load values; and injecting hints into the executable code to indicate the identified instructions to a second processor that executes the executable code. A non-transitory computer-readable medium comprising executable code with hints injected by the first processor is also provided, in addition to a second processor for executing the executable code with the injected hints.

### TECHNICAL FIELD

The technical field generally relates to high-performance processors, and more specifically to load value prediction for increasing performance of dependent sequences of instructions.

### BACKGROUND

Modern high-performance processors can issue and execute multiple instructions simultaneously for better performance. However, true data dependency in the instruction chain blocks the opportunity of executing dependent instructions in parallel.

Value prediction was proposed in the mid-90s to improve the performance of central processing units (CPUs) by breaking true data dependency. Value prediction is a hardware technique that uses a value predictor table to predict the result of a first instruction so that a subsequent instruction can be issued to execution at the same cycle as the first instruction.

However, there are two main inefficiencies with conventional value prediction methods. First, a large storage space is needed to obtain good coverage on existing load instructions. Second, training time overhead is required to reduce pipeline flush caused by misprediction.

One of the state-of-the-art value prediction solution is the value tagged geometric length (VTAGE) predictor proposed in A. Perais and A. Seznec, "Practical data value speculation for future high-end processors," 2014 IEEE 20th International Symposium on High Performance Computer Architecture (HPCA), the entirety of which is incorporated herein by reference. VTAGE is a context-based value predictor leveraging global branch history as context. A base predictor VT0 is indexed using the instruction program counter (PC) whereas other tables are indexed using the hash value of instruction PC and various numbers of bits from the global branch history. For example, VT1 uses the hash of instruction PC and one bit from the global branch history. VTAGE using multiple tables indexed with instruction PC and global branch history bits to provide context-sensitive predictions. As a result, the table using longest global branch history bits captures the longest context.

Starting with a first instruction in the FETCH stage, with current global branch history bits hashed with the first instruction PC, VTAGE value predictor tables are queried to find predictions. If matches are found from multiple tables, for each prediction, a confidence level is checked to see if it is above a certain threshold. If multiple predictions pass the check, then the prediction from the longest global branch history table is selected as the prediction.

However, there are two main disadvantages of VTAGE. First, VTAGE being a hardware value predictor, all training is done on the hardware during runtime. In the event of a misprediction happening, a pipeline flush is issued therefore incurs additional penalty. To reduce the number of mispredictions, a certain confidence level of a predicted value needs to be obtained. VTAGE uses confidence bits, upon seeing the same value, the confidence bit gets incremented. For VTAGE, the prediction can be sent out to execution when eight occurrences of the same value are loaded. Therefore, at least eight occurrences of the same instruction are needed to train the value predictor.

Second, storage space is required to keep the instruction PC and the predicted value and peripheral bits such as confidence and usefulness bits. VTAGE uses 128KB storage space for 8K entries since multiple tables are used with various length of the global branch history. To achieve higher performance, a high coverage on load instructions is preferred. However, there's a tradeoff between coverage and access time. Nonetheless, under the constraint of access time, a large storage space is needed, otherwise, useful entries will be kicked out of the value predictor table.

In view of the above, there is a need to overcome the deficiencies of prior art of hardware-only approaches for value prediction, including long training time needed for accurate prediction, and large storage space required to achieve high coverage.

### SUMMARY

The invention described herein is a software and hardware co-design technology for load value prediction. The invention uses software profile analysis to identify instructions that are easy to predict, e.g., load instructions that always load in the same value, then uses a compiler to provide hints for hardware to only predict these types of instructions. As a result, the invention can reduce the training time on hardware, and reduce storage space required by only keeping profitable entries in the value predictor table. Moreover, by identifying instructions that are easy to predict ahead of time, more aggressive instruction level parallelism can be achieved, allowing for better performance improvements without the negative impact caused by mispredictions generated from predicting hard-to-predict instructions.

According to an aspect, a method for load value prediction is provided. The method includes receiving executable code, processing the executable code to identify instructions that have substantially stable load values, and injecting hints into the executable code to indicate the identified instructions. The hints can be used by a processor that executes the instructions to perform load value prediction only on the identified instructions, thereby allowing the processor to focus on instructions that are profitable to predict and thus reducing training time at runtime, reducing required storage space, and avoiding utilizing resources to predict non-profitable instructions. In some configurations, processing the executable code and injecting the hints are carried out by one or more first processors, such as a processor of a compiler. Executing the hint-injected instructions can be performed on a second processor, such as a high-performance CPU.

In some embodiments, the hints are configured to cause the second processor to preload a value predictor table with the identified instructions prior to executing the identified instructions.

In some embodiments, processing the executable code includes identifying instructions having substantially stable load values in predetermined intervals of instructions, and wherein the hints are configured to cause the second processor to preload the value predictor table with the identified instructions prior to executing the intervals of instructions.

In some embodiments, processing the executable codes includes, for each interval of instructions: identifying a trigger memory address associated with a beginning of the interval, and identifying instructions in the interval having substantially stable load values; and wherein the hints are configured to cause the second processor to, upon executing an instruction at the trigger memory address, load the instructions in the interval having substantially stable load values into the value predictor table.

In some embodiments, preloading the value predictor table includes loading memory addresses corresponding to the identified instructions as entries in the value predictor table.

In some embodiments, preloading the value predictor table further includes populating the entries in the value predictor table with predicted load values for the identified instructions.

In some embodiments, injecting hints includes embedding load value profile metadata into the executable code, further wherein the second processor is configured to regularly query the load value profile metadata to preload the value predictor table with the identified instructions prior to executing the identified instructions.

In some embodiments, injecting hints includes injecting instructions into the executable code that instruct the second processor to preload the value predictor table prior to executing the identified instructions.

In some embodiments, injecting hints includes setting reserved bits in the instructions of the executable code, the reserved bits distinguishing the instructions having substantially stable load values from instructions not having substantially stable load values.

In some embodiments, the second processor is configured to verify the reserved bits when fetching instructions, and to perform load value prediction on fetched instructions only if the reserved bits indicate that the instructions have substantially stable load values.

In some embodiments, identifying instructions having substantially stable load values includes identifying instructions that load a constant value in a predetermined interval of instructions, or that load the constant value above a predetermined consistency threshold during the predetermined interval of instructions.

According to an aspect, a non-transitory computer-readable medium is provided. The computer-readable medium has executable code stored thereon that includes: a plurality of instructions which, when executed by a processor, cause the processor to load values into memory; and a plurality of hints identifying at least some of the plurality of instructions that cause the processor to load substantially stable values. The instructions can be identified, and the hints can be injected, according to the method described above. The hints can be used by the processor to perform load value prediction only on the identified instructions, as also described above.

In some embodiments, the plurality of hints include load value profile metadata indicating memory addresses of instructions that cause the processor to load substantially stable values.

In some embodiments, the load profile metadata indicates predicted load values associated with the instructions that cause the processor to load substantially stable values.

In some embodiments, the load value profile metadata includes a table having a plurality of entries, each entry corresponding to an interval in the plurality of instructions and including a list of memory addresses associated with instructions within the interval that cause the processor to load substantially stable values.

In some embodiments, the plurality of hints include instructions that cause the processor to preload a value predictor table prior to executing subsequent instructions that are included in the value predictor table.

In some embodiments, the plurality of hints include reserved bits in the plurality of instructions that distinguish instructions having substantially stable load values from instructions that do not have substantially stable load values.

According to an aspect, a processor is provided for executing executable code loaded in memory. The executable code includes hints injected therein, for example as described in the method above. The processor is configured to: fetch instructions from the memory into an instruction pipeline; determine whether hints in the executable code indicate the instructions as loading substantially stable values; and execute the instructions, wherein the instructions are executed using load value prediction based on whether the instructions are indicated as loading substantially stable values.

In some embodiments, the processor is configured to determine whether the instructions are indicated as loading substantially stable values by querying a pre-populated value predictor table to determine whether entries for the instructions exist in the value predictor table.

In some embodiments, the processor is configured to determine whether the instructions are indicated as loading substantially stable values by verifying reserved bits associated with the instructions.

### BRIEF DESCRIPTION OF THE DRAWINGS

FIG. 1A is a schematic illustrating schedule of an exemplary instruction sequence in a processor pipeline.

FIG. 1B is a schematic illustrating scheduling of the instruction sequence of FIG. 1A in a processor pipeline using a trained value predictor table.

FIG. 2 is a flowchart illustrating an exemplary method for load value prediction.

FIG. 3 is a schematic illustrating an exemplary value predictor table that can be used in the load value prediction method of FIG. 2.

FIG. 4 is a flowchart illustrating a software-side method for assisting load value prediction, in accordance with an embodiment.

FIG. 5 is a flowchart illustrating a hardware-side method for load value prediction, in accordance with an embodiment.

FIG. 6 is a schematic illustrating an exemplary method for formulating load value profile metadata.

FIG. 7 is a schematic illustrating an exemplary executable with injected vpload instructions.

FIG. 8 is a flowchart illustrating a hardware-side method for load value prediction based on hints provided in reserved bits of instructions, in accordance with an embodiment.

FIG. 9 is a schematic illustrating an exemplary computing environment for implementing a software and hardware co-design for load value prediction.

### DETAILED DESCRIPTION OF ILLUSTRATIVE EMBODIMENTS

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary implementations described herein. However, it will be understood by those of ordinary skill in the art that the implementations described herein may be practised without these specific details. In other instances, well-known methods, procedures and components have not been described in detail so as not to obscure the implementations described herein. Furthermore, this description is not to be considered as limiting the scope of the implementations described herein in any way but rather as merely describing the implementation of the various implementations described herein.

In the present disclosure, “at least one” means one or more, and “a plurality of” means two or more. The expression “and/or” describes an association relationship of associated objects, and indicates that there may be three relationships. For example, “A and/or B” includes “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, all three of “at least one of a, b, or c”, “at least one of a, b, and c” and “at least one of a, b, and/or c” may represent “a”, “b”, “c”, “a and b”, “a and c”, “b and c”, or “a, b and c”, where a, b, and c may be a single or multiple form.

In the following description, an implementation or a configuration are examples or a possible embodiment. The various appearances of "one implementation", "an implementation" or "some implementations" do not necessarily all refer to the same implementations. Although various features may be described in the context of a single implementation, the features may also be provided separately or in any suitable combination. Conversely, although the invention may be described herein in the context of separate implementations for clarity, it may also be implemented in a single implementation. Reference in the specification to "some implementations", "an implementation", "one implementation" or "other implementations" means that a particular feature, structure, or characteristic described in connection with the implementations is included in at least some implementations, but not necessarily all implementations.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in implementations other than the ones outlined in the description above. It is to be understood that the terms "including", "comprising", and grammatical variants thereof do not preclude the addition of one or more components, features, steps, or integers or groups thereof and that the terms are to be construed as specifying components, features, steps or integers. If the specification or claims refer to "an additional" element, that does not preclude there being more than one of the additional element. It is to be understood that where the claims or specification refer to "a" or "an" element, such reference does not mean that there is only one of that element. It is to be understood that where the specification states that a component, feature, structure, or characteristic "may", "might", "can" or "could" be included, that particular component, feature, structure, or characteristic is not required to be included.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. It will be appreciated that the methods described herein may be performed in the described order, or in any suitable order.

In the present disclosure, the terms “a” or “an” are defined to mean “at least one”, that is, these terms do not exclude a plural number of items, unless stated otherwise.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the following description, the expression “processor” is used to refer to a physical or logical computing component that can execute instructions and process data. Such a processor relies on a clock to synchronize operations in discrete cycles. A processor may comprise a general-purpose processor, a central processing unit (CPU), a graphics processing unit (GPU), a neural processing unit (NPU), a system on chip (SoC) or another programmable logic device, a discrete gate or transistor logic device, or a discrete hardware component. A processor may implement or perform the methods, the steps, and the logical block diagrams that are disclosed in the embodiments of the present disclosure. A general-purpose processor may be a microprocessor, or the processor may be any conventional processor or the like. The steps of the methods disclosed with reference to the embodiments of the present disclosure may be directly performed and completed by a hardware decoding processor, or may be performed and completed by using a combination of hardware in the decoding processor and a software module. The software module may be provided in a storage medium, such as a random-access memory, a flash memory, a read-only memory, a programmable read-only memory, an electrically erasable programmable memory, or a register. The storage medium may be loaded into memory, and the processor reads information in the memory and completes the steps of the foregoing methods in combination with hardware in the processor.

It may be understood that the memory in the embodiments of the present application may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random-access memory (Random Access Memory, RAM) and is used as an external cache. By way of example rather than limitation, many forms of RAMs may be used, and are, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchronous link DRAM, SLDRAM), and a direct rambus random access memory (Direct Rambus RAM, DR RAM).

The following is an example sequence of instructions executed by a processor that illustrates true data dependency:
LDR R1, [R2]
ADD R3, R1, R4
MUL R5, R3, R6.

In this example, the LDR instruction loads in a value from the address R2 to register R1. The ADD instruction adds the value in R1 with R4 and saves the result to R3. The MUL instruction multiplies the value in R3 and R6 and saves the result to R5. True data dependency exists between the consecutive instructions. The result of the LDR instruction is the input for the ADD instruction and the result of the ADD instruction is the input for the MUL instruction. Therefore, these three instructions cannot be executed simultaneously. Since typically memory operations like LDR will take several processor cycles, the subsequent ADD instruction have to wait the same amount of time until the result is ready to be issued to execution.

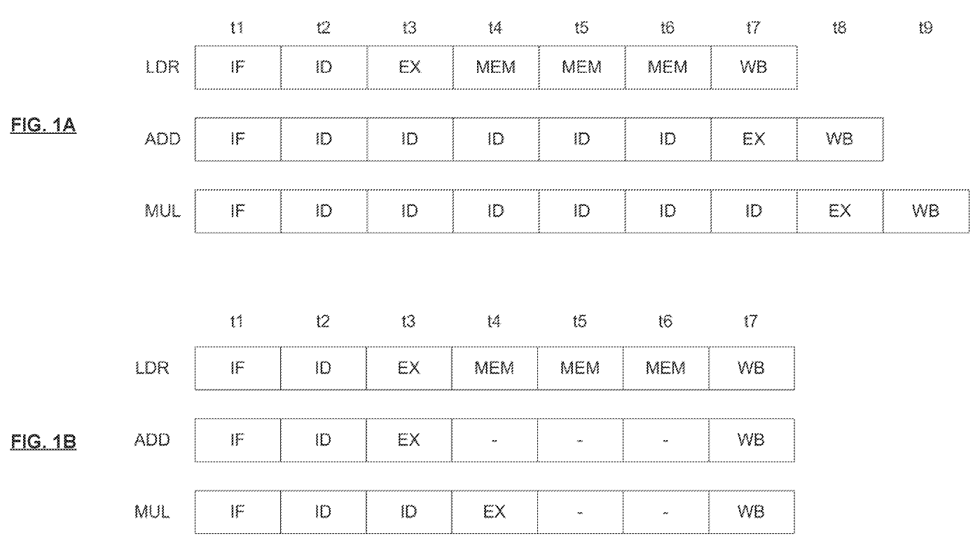

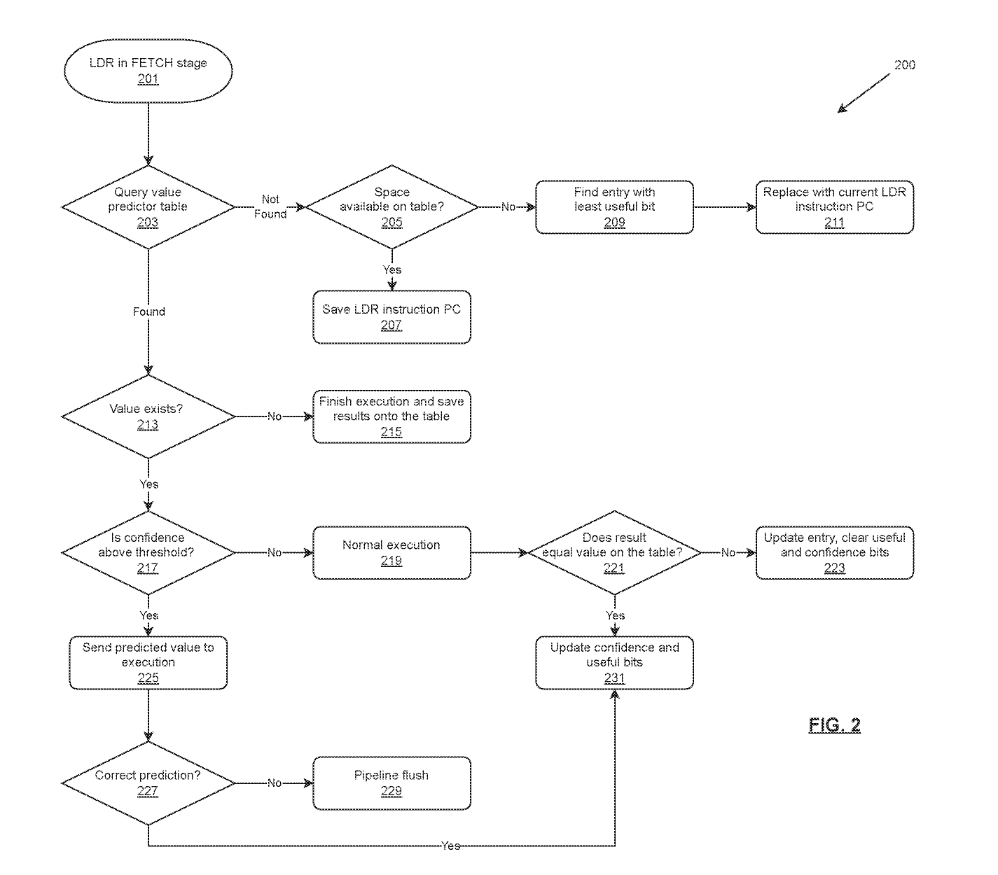

FIG. 1A shows the scheduling of the instruction sequences in the above example in the processor pipeline. In this example, the processor has a fetch width of four instructions, so the LDR, ADD and MUL instructions can be fetched in the same processor cycle t1. At t2, these three instructions are decoded and since the input is ready for LDR instruction, it can be sent to execution at t3, while the LDR and MUL instructions are stalled in decode stage at t2 since the input for the two instructions are not available yet. In this example, the LDR instruction takes two processor cycles to load the result from memory. The ADD instruction can then be sent to execution at t6 and takes one processor cycle for execution, and then the MUL instruction is sent to execution at t7. In this scenario, even if the processor can execute multiple instructions simultaneously, these three instructions must be executed sequentially. Resources such as arithmetic and logic units on the processor are left in idle state for several processor cycles due to data dependency.

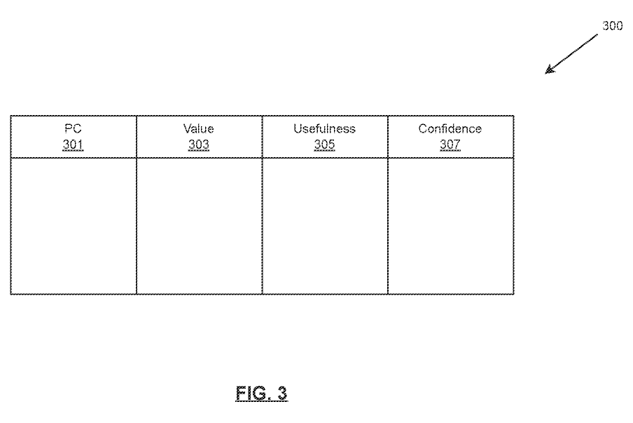

An exemplary method 200 for load value prediction is shown in FIG. 2. The illustrated method 200 can allow improving processor performance when executing instructions having data dependency, such as the exemplary instruction sequence provided above. Broadly described, the method 200 utilizes a value predictor table to predict the result of initial instructions so that subsequent instructions can be issued to execution at the same cycle as the initial instructions. An exemplary value predictor table 300 that can be used as part of method 200 is illustrated in FIG. 3. In the illustrated example, the value predictor table 300 comprises four columns 301, 303, 305, and 307. Each entry on the table corresponds to an instructions that can be predicted: the first column 301 stores a program counter (PC) value corresponding to the instruction, i.e. an address in memory pointing to that instruction; the second column 303 stores a predicted value for the instruction; the third column 305 stores a usefulness associated with the predicted value of the instruction, such as the number of times the predicted value of the instruction has been used or requested; and the fourth column 307 stores a confidence associated with the predicted value of the instruction, such as a number of times the predicted value has been confirm as being the correct value. Although four columns 301, 303, 305, and 307 have been illustrated and described, it is appreciated that a different number and/or configuration of columns is possible depending on the value prediction method that is used. Moreover, although a single table is illustrated, it is appreciated that some value prediction methods can utilize multiple value predictor tables and/or that data in a given value predictor table can be organized among separate tables as needed, and that the expression “value predictor table” can refer to a single table or to multiple tables.

In more detail now, method 200 starts with an LDR instruction entering the FETCH stage of the processor pipeline 201. In a subsequent step 203, a value predictor table is queried to see if an entry is found with the PC of the LDR instruction. If the PC is not found in the table, an entry is to be created for the current LDR instruction on the value predictor table. A check can be conducted 205 to determine if there is space available on the predictor table. If there is space available, a new entry can be created in the table with the PC of the LDR instruction 207. If the value predictor table is full, an entry with the least usefulness level is selected 209 and replaced by the current LDR instruction 211. The usefulness level and confidence level of the entry can then be cleared.

If an entry is found in the value predictor table, then another check 213 is done to see if a predicted value exists for that entry. If there is no predicted value associated with the entry found in the value predictor table, the LDR instruction is to continue its normal execution and at commit stage the entry is updated such that the predicted value corresponds to the result of the instruction 215. If a value exists from the check in 213, then the confidence level is checked to see if it is greater than a predetermined threshold 217. If the confidence level of the predicted value is smaller than the predetermined threshold, then no prediction is given by the value predictor table, and the LDR continues its normal execution in the processor pipeline 219. At its commit stage, the result is checked with the value from the value predictor table 221. If the two are the same, the confidence level is incremented 231, otherwise, the value on the value predictor table is updated and the confidence and usefulness level are cleared 223. If the confidence value of the predicted value is greater than or equal to the predetermined threshold at step 217, the value has gained enough confidence level and can be sent out as a prediction 225 such that subsequent instructions can be scheduled for immediate execution in parallel with the predicted instruction, based on the predicted value. To ensure the correctness of the program, the predicted value is sent out speculatively. More specifically, the actual result of the LDR instruction is checked with the predicted value at its execution stage 227. If predicted correctly, then the confidence level and usefulness level of the prediction entry are incremented 231. Otherwise, a pipeline flush 229 is performed to clear the effect of the misprediction. In other words, the sequence of instructions can be executed anew. Alternatively, a selective flushing and re-issue of affected instructions can be performed, such that the pipeline is reverted back to the state as if there was no value prediction.

FIG. 1B shows the scheduling of the exemplary instruction sequence presented above in the processor pipeline with a trained value predictor table. At t3 cycle, LDR and ADD can be sent to execution stage simultaneously given a predicted value. The MUL instruction is then sent to execution at the following cycle since the ADD instruction takes one cycle to finish execution. Since the ADD and MUL are executed based on the predicted value, they are executed speculatively. More specifically, they are stalled before the writeback stage waiting to check if the prediction was correct. In this example, the load value is predicted correctly, therefore the LDR, ADD and MUL instructions can be committed at the same cycle t7. Compared with the processor pipeline execution without value prediction in FIG. 1A, one processor cycle is saved for the MUL instruction, furthermore, as the dependence chain gets longer, more processor cycles can be saved.

As can be appreciated from the exemplary method 200 described above, where the predictor table is not pre-populated, several iterations may be needed to “train” the value predictor table, i.e., to create sufficient entries with sufficiently confident predicted values. Since power and energy are wasted for flushing instructions affected by mispredictions, the confidence value threshold can be configured such that only when the same value has been observed multiple times can it be sent out as a valid prediction. However, this can require a large training time overhead. Moreover, since older or less useful instructions are replaced in the value predictor table, a large storage space may be needed to ensure a large enough coverage, i.e. to allow for enough entries on the predictor table that will allow for a measurable performance gain. However, storage space can be limited depending on the implementation.

The above-described method 200 can be said to be a hardware-only approach, whereby it is implemented by the processor that executes the instructions. As described above, such a hardware-only approach can suffer from drawbacks including (1) long training time needed for accurate prediction, and (2) a large storage space required to achieve high coverage.

To overcome the deficiencies of the above-described method, a software and hardware co-design can be provided. More specifically, a software-assisted load value prediction method can be implemented where offline software profile analysis is used to identify instructions that are easy to predict (also referred to as “profitable” instructions), e.g., load instructions that substantially stable in that they often or always load in the same value. The identified instructions can then be indicated via hints, such that the hardware (i.e., the processor that executes the instructions) only predicts the identified instructions at runtime. Such hints can, for example, be injected via a compiler, binary optimizer, or other suitable tool. As a result of only keeping profitable entries in the value predictor table, the training time on hardware and the required storage space can be reduced.

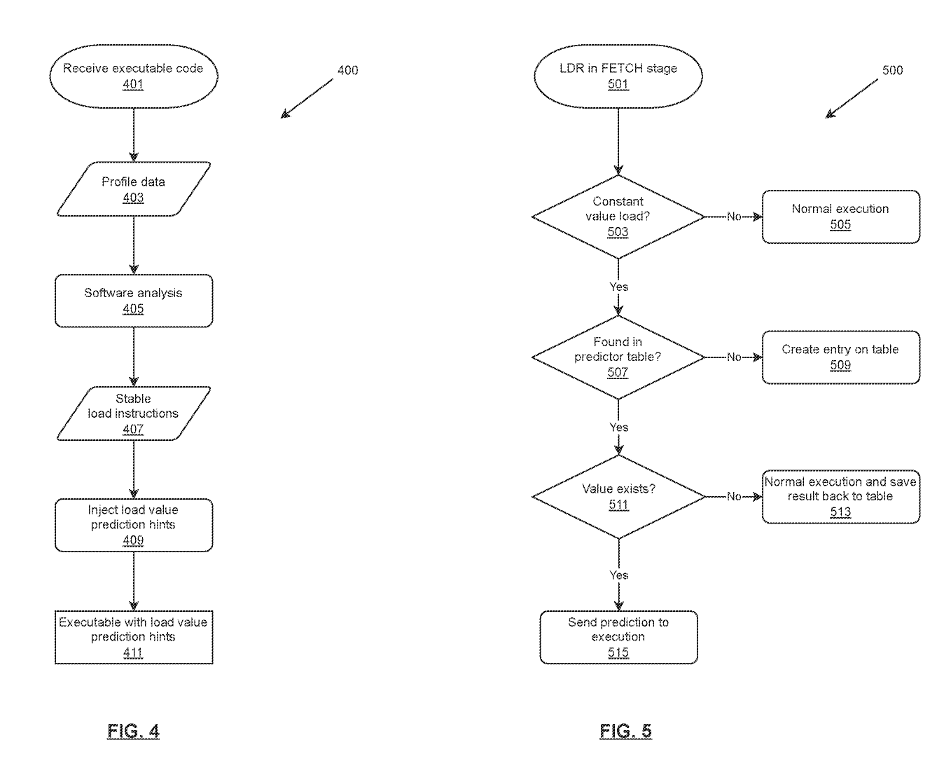

An exemplary software-side method 400 for assisting load value prediction is shown in FIG. 4. The method 400 can be carried out on one or more first processors, such as one or more processors that execute code implementing tools such as software profilers, compilers, and/or binary optimizers, among others. The method 400 begins with receiving executable code 401. The executable code can, for example, be a software application or program defined by a plurality of computer-executable instructions stored on non-transitory computer-readable memory. The executable code 401 can be received in different forms, such as in the form of uncompiled code, or in the form of a compiled binary.

Subsequent steps can involve processing the executable code to identify instructions in the executable code that have substantially stable load values (referred to hereinafter as “stable load instructions”). In the present embodiment, this involves extracting and/or otherwise obtaining software profile data 403. Software profile data can include any data that measures or characterizes the performance of a software application implemented by the executable code, such as data that measures processor usage, memory consumption, the usage of particular instructions, the frequency or duration of function calls, etc. The software profile data can be obtained using any suitable tool, such as a software profiler. The software profile data can then be analyzed in step 405, and stable load instructions can be identified therefrom 407.

As can be appreciated, stable load instructions can be identified in different manners and based on different criteria. In some embodiments, instructions that always load the same value (i.e. instructions that load a constant value) can be identified as stable load instructions. In some embodiments, instructions that load the same value above a predetermined consistency threshold (e.g., above a predetermined %) can be identified as stable load instructions. In some embodiments, the identification of stable load instructions can be carried out for predetermined timeframe, such as within predetermined intervals of instructions within the executable code. For example, instructions that always load the same value or that load the same value above a predetermined consistency threshold within a given interval of instructions can be identified as stable load instructions. As can be appreciated, the intervals of instructions can be defined in different ways. In some embodiments, the stability of instructions can be evaluated within any interval of a predetermined number of instructions, such as within any interval of 10k instructions. In some embodiments, the stability of instructions can be evaluated within a specific interval, such as within the first 10k instructions, or within a first number of times a given instruction is executed.

Once stable load instructions have been identified 407, corresponding hints can subsequently be generated and/or injected into the executable code in step 409. The hints can be injected using different techniques, for example by adding metadata to the executable code, by setting reserved bits in instructions in the executable code, or by adding instructions into the executable code, as will be discussed in more detail hereinbelow, among others. The hints can be injected using any suitable tool, such as a compiler or a binary optimizer, thereby generating an executable comprising load value prediction hints 411.

The executable 411 can comprise executable code that is stored on a non-transitory computer-readable medium. This executable 411 can be provided to a second processor which can execute the code and perform an improved hardware-side value prediction process by leveraging the hints. The executable code can include a plurality of instructions which, when executed by the second processor, cause the second processor to load values into memory, and a plurality of hints identifying at least some of the plurality of instructions that cause the second processor to load substantially stable values. As will be described in more detail hereinafter, the configuration of the executable 411 and injected hints can vary depending on how the hints are injected. However, it is appreciated that the hints can be configured to cause the second processor to preload a value predictor table with identified stable instructions prior to executing such identified instructions and/or subsequent instructions that depend from such identified instructions.

With reference now to FIG. 5, an exemplary hardware-side method 500 for load value prediction is shown according to an embodiment. The illustrated method 500 is carried out using an executable such as the executable 411 described above, and can be executed by a second processor which can be different from the first processor. Although not illustrated, it is appreciated that method 500 can include similar steps as method 200 described above. However, method 500 includes additional steps that allow hints in the executable 411 to be leveraged when performing load value prediction during runtime in hardware.

Broadly described, method 500 involves carrying out an initial check using hints in the executable 411 to determine whether an instruction is identified as being a stable load instruction. Value prediction steps can then be carried out only on instructions identified as being stable, whereas instructions not identified as being stable can proceed to normal execution. In other words, instructions not identified as being stable can be ignored by the value predictor such that no training time or storage space is used for such instructions.

In more detail now, method 500 starts with a LDR instruction in the FETCH stage 501. An initial check 503 is carried out using hints in the executable 411 to determine whether the LDR instruction was identified through the software analysis as being stable load instruction. If the LDR instruction is not identified as being a stable load instruction, the LDR instruction can proceed to normal execution 505 without load value prediction. Otherwise, subsequent steps can be carried out to perform value prediction on the LDR instruction.

As can be appreciated, the check 503 can be carried out in different ways depending on the format of the hints in the executable 411. In some embodiments, the check 503 can be carried out explicitly, for example by reading metadata or reserved bits associated with the LDR instruction to determine whether the LDR is flagged as being a stable load instruction. In some embodiments, the check 503 can be carried out implicitly, for example by pre-loading the predictor table with entries corresponding only to stable load instructions, and causing the value prediction process to proceed only on pre-loaded entries. Exemplary methods for performing the check 503 will be described in more detail in connection with different configurations of executable 411 presented below.

As can be appreciated, where the LDR instruction is identified as being a stable load instruction, the subsequent steps that are carried out can vary according to the value prediction method that is used and/or according to the format of the hints in the executable. In the illustrated embodiment, the subsequent steps include querying the predictor table 507 for an entry corresponding to the LDR instruction. If an entry for the LDR instruction is not found, a new entry can be created on the table 509. Otherwise, the entry can be checked 511 to determine whether a predicted value exists for that entry. If a value does not exist, the LDR instruction can be executed normally, and the entry can be updated such that its predicted value corresponds to the result of the LDR instruction 513. If a predicted value exists for the entry, then the value can be sent as a prediction for immediate execution of subsequent instructions 515. In some embodiments, step 509 can be omitted. For example, in embodiments where the value predictor table is pre-loaded with entries corresponding only to stable instructions, method 500 can involve performing predictions only on such pre-loaded entries, such that new entries do not need to be created. In some embodiments, step 513 can be omitted. For example, in embodiments where the value predictor table is pre-loaded with predicted values, method 500 can involve performing predictions using such pre-loaded predicted values without needing an additional step to train the predicted values.

Although not illustrated, it is appreciated that more complex value prediction methods can be carried out as part of method 500 provided such value prediction methods are performed only for instructions identified as being stable. As an example, step 509 can include sub steps such as steps 205, 207, 209, and 211 described above in connection with method 200, for creating an entry on the predictor table. As another example, step 511 can include sub steps such as steps 217, 219, 221, 223, and 231 described above in connection with method 200 for deciding when to use a prediction, and for updating confidence and usefulness bits. As another example, step 515 can include sub steps such as steps 227, 229, and 231 described above in connection with method 200, for verifying the correctness of a prediction and taking appropriate action. As yet a further example, the value prediction method can be implemented by a VTAGE predictor, and steps 507 and 511 can involve querying multiple tables.

As mentioned above, the configuration of executable 411 can vary depending on how hints are injected through the offline software analysis. The hardware-side value prediction method can also vary depending on the format of the hints.

In a first configuration, hints are provided via the metadata section of the executable 411. At runtime the metadata can be loaded into Dynamic Random-Access Memory (DRAM) of the hardware executing the executable, and the hardware can read the metadata to identify stable instructions and/or to prefetch or prepopulate the value predictor table with such stable instructions. For example, the hints can comprise load value profile metadata that indicate memory addresses (such as the PC) of stable load instructions. During runtime, the hardware can be configured to prefetch or prepopulate the value predictor table by creating entries for the memory addresses indicated in load value profile metadata. In some embodiments, the load value profile metadata can further indicate predicted values associated with the stable load instructions. During runtime, the hardware can be configured to prepopulate entries in the value predictor table with the corresponding predicted values.

In other words, in the first configuration of executable 411, the hints provided as part of the executable include load value profile metadata indicating memory addresses of instructions that cause a processor to load substantially stable values. The load profile metadata may further indicate predicted load values associated with the instructions that cause the processor to load substantially stable values.

To formulate the load value profile metadata, the software analysis 405 can involve analyzing an execution trace of the executable code operating on a workload to identify stable load instructions. Memory addresses corresponding to the stable load instructions can then be recorded to be included as part of the load value profile metadata.

As can be appreciated, real world applications can exhibit temporal locality tendency in execution. In other words, the same instruction is likely to be used again within a short amount of time. Therefore, within a short period, only a set of entries on the value predictor table is accessed. Using this characteristic, the storage space required for the value predictor can be reduced by preloading a set of frequently used stable load instructions onto the value predictor table.

More specifically, given profile data 403 comprising an execution trace on a workload, the software analysis 405 can identify stable load instructions in given intervals of n instructions. Hints can then be generated which cause the value predictor table to be preloaded with the stable load instructions identified the given intervals of n instructions prior to executing such given intervals of instructions. For example, a table of load value profile metadata can be generated where the index for each entry is the start PC of a given interval of n instructions, and the value of each entry is populated with a list of stable load instruction PCs in that given interval of n instructions. This table is then embedded into the executable code 411 to provide load value prediction hints to the hardware.

In other words, the load value profile metadata can comprise a table having a plurality of entries, each entry corresponding to an interval of instructions and comprising a list of memory addresses associated with instructions within the interval that cause a processor to load substantially stable values. The load value profile metadata can be generated by identifying instructions having substantially stable load values in predetermined intervals of instructions and, for each interval of instructions: identifying a trigger memory address associated with a beginning of the interval, and identifying instructions in the interval having substantially stable load values. The identified trigger memory address and the identified instructions can be formatted as an entry in a table that causes a processor to, upon executing an instruction at the trigger memory address, load the identified instructions for the corresponding interval into the value predictor table.

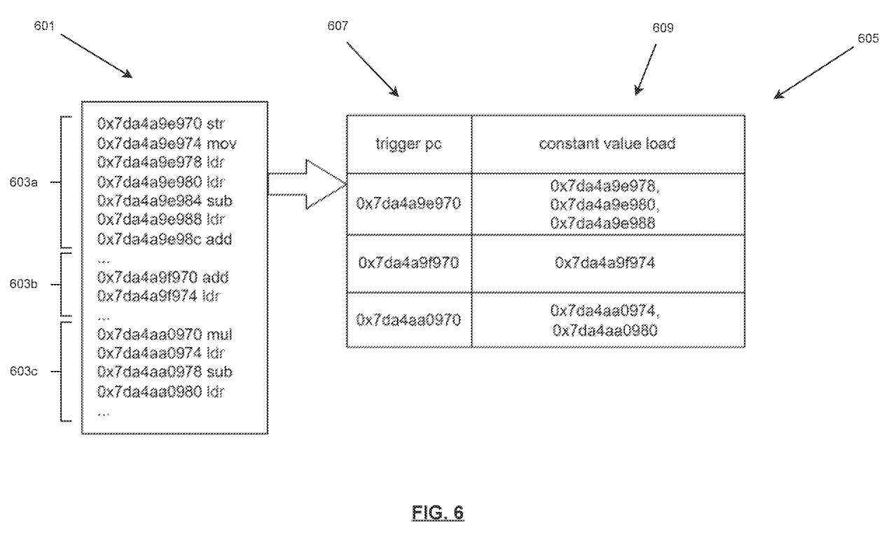

An example of the formulation of load value profile metadata from an execution trace is illustrated in FIG. 6. In this example, a provided execution trace 601 is broken into intervals of 4096 instructions 603a, 603b, 603c. For each interval, stable load instructions can be identified based on the resulted loaded value. For example, in a first interval 603a from 0x7da4a9e970 to 0x7da4a9f970, the identified stable load instructions are the LDR instructions with PCs of 0x7da4a9e978, 0x7da4a9e980, and 0x7da4a9e988. An entry is created on a load value profile metadata table 605 with the index 607 (also referred to as the “trigger PC”) 0x7da4a9e970 corresponding to the PC at the start of the first interval 603a, and with a value 609 comprising a list of the PCs of the identified stable load instructions. Similar steps can be carried out to create entries for the remaining intervals 603b, 603c. Although in the illustrated example, the execution trace is broken down into intervals of n = 4096 instructions, it is appreciated that other intervals are possible. Also, although in the illustrated example all identified stable load instructions are included in the value profile metadata table 605, it is appreciated that to limit the storage space for the metadata, a selection of only the most frequently executed stable load instructions can be saved into the metadata and embedded into the executable code.

In the illustrated example, the value profile metadata table 605 includes only the PCs of stable load instructions associated with a given trigger PC. However, it is appreciated that in other configurations, the value profile metadata table 605 can also include predicted values associated with the load instructions.

During runtime execution on hardware, the index 607 for each entry on the table 605 acts as a trigger, such that when the trigger PC in the index 607 enters the commit stage, the value profile metadata is queried to obtain the corresponding list of stable load instructions PCs 609. The value predictor table can then be preloaded with the list of stable load instructions, such that value prediction can be carried out on those stable load instructions once they are executed. As can be appreciated, a processor can regularly query the value profile metadata to preload the value predictor table as needed prior to executing stable instructions that are identified in the value profile metadata.

As can be appreciated, the way in which the value predictor table is preloaded can vary depending on the configuration of the value profile metadata table 605. In some embodiments, both the PCs and predicted values for stable instructions can be stored in the value profile metadata table 605. In such embodiments, the value predictor table can be preloaded with both instruction PCs and corresponding predicted values, such that training is not required at runtime execution on hardware. However, this may involve additional overhead when preloading the value predictor table. It may also require more storage space for the profile metadata table 605. In other embodiments, only the PCs for stable instructions can be stored in the value profile metadata table 605. In such embodiments, the overhead of preloading the value predictor table can be reduced. Moreover, the storage space required for the profile metadata table 605 can be reduced. However, a training iteration will be needed at runtime on hardware to populate the value predictor table with predicted values. More specifically, since only stable instruction PCs are preloaded, this merely provides a hint to hardware that these instructions are likely to load in stable values. The first occurrence of such instructions will be a training iteration, such that those instructions go through the execution pipeline and the result is stored back into the value predictor table as a predicted value. Subsequent occurrences of such instructions can then benefit from the value prediction using the trained value predictor table. In some configurations, the confidence of the predicted value can be presumed, such that no further training iterations are required after a first occurrence of the instruction. In other configurations, several training iterations may still be needed to achieve a desired level of confidence for the instruction. However, it is appreciated that the confidence threshold that needs to be met can be reduced compared to a value predictor that operates without hints from offline software analysis.

In a second configuration of the executable 411, hints are provided in the form of new instructions that are injected into the executable 411. Such new instructions are referred to hereinafter as “vpload” instructions, but it is appreciated that the instructions can be named differently. The vpload instructions serve to preload stable load instructions to the value predictor table as needed during runtime execution of the executable 411. Similar to the first configuration described above, this involves a preload mechanism to populate the value predictor table prior to executing stable load instructions and/or instructions dependent thereon. However, instead of storing metadata in DRAM, the stable load instructions to preload on the value predictor table is embedded in the vpload instructions.

As can be appreciated, different configurations of the vpload instructions are possible. In some configurations, the vpload instructions can cause both stable load instruction PCs and corresponding predicted values to be loaded into the value predictor table. In such configurations, predicted values will be ready to use before the dispatch of instructions dependent on them. Advantageously, such configurations do not require training at runtime execution on hardware. However, there may be an additional overhead incurred with preloading values into the value predictor table. In some configurations, the vpload instructions can cause only the PCs for stable load instructions to be loaded into the value predictor table. In such configurations, the overhead of preloading the value predictor table can be reduced. However, a training iteration will be needed at runtime on hardware to populate the value predictor table with predicted values. More specifically, since only stable instruction PCs are preloaded, this merely provides a hint to hardware that these instructions are likely to load in stable values. The first occurrence of such instructions will be a training iteration, such that those instructions go through the execution pipeline and the result is stored back into the value predictor table as a predicted value. Subsequent occurrences of such instructions can then benefit from the value prediction using the trained value predictor table. In some configurations, the confidence of the predicted value can be presumed, such that no further training iterations are required after a first occurrence of the instruction. In other configurations, several training iterations may still be needed to achieve a desired level of confidence for the instruction. However, it is appreciated that the confidence threshold that needs to be met can be reduced compared to a value predictor that operates without hints from offline software analysis.

As can be appreciated, the vpload instructions can be formulated in a similar manner as the load value profile metadata described above in connection with the first configuration of executable 411. More specifically, the software analysis 405 can involve analyzing an execution trace of the executable code operating on a workload to identify stable load instructions. Memory addresses corresponding to the stable load instructions can then be recorded to be included as part of vpload instructions. The vpload instructions must be injected within existing instruction in the executable 411 in a timely manner so that the predicted values will be ready to use before the dispatch of instructions dependent on them. For example, this can involve injecting a vpload instruction at a memory address within the executable 411 that will be executed prior to execution of a stable load instruction referenced in said vpload instruction.

In some instances, a vpload instruction can cause a single stable load instruction PC to be loaded into the value predictor table. In other instances, a vpload instruction can cause a plurality of stable load instruction PCs to be loaded into the value predictor table. For example, as described in connection with the first configuration of executable 411, the software analysis 405 can involve identifying stable load instruction in given intervals of n instructions. Vpload instructions can then be injected into the executable 411 prior to execution of those intervals of instructions to preload the value predictor table with a plurality of stable load instructions identified in the corresponding intervals of instructions.

In other words, vpload instructions can be generated by identifying instructions having substantially stable load values in predetermined intervals of instructions and, for each interval of instructions: identifying a trigger memory address associated with a beginning of the interval, and identifying instructions in the interval having substantially stable load values. A vpload instruction can be injected into the executable at a memory address prior to the identified trigger memory address to cause a processor executing the vpload instruction to load the identified instructions for the corresponding interval into the value predictor table.

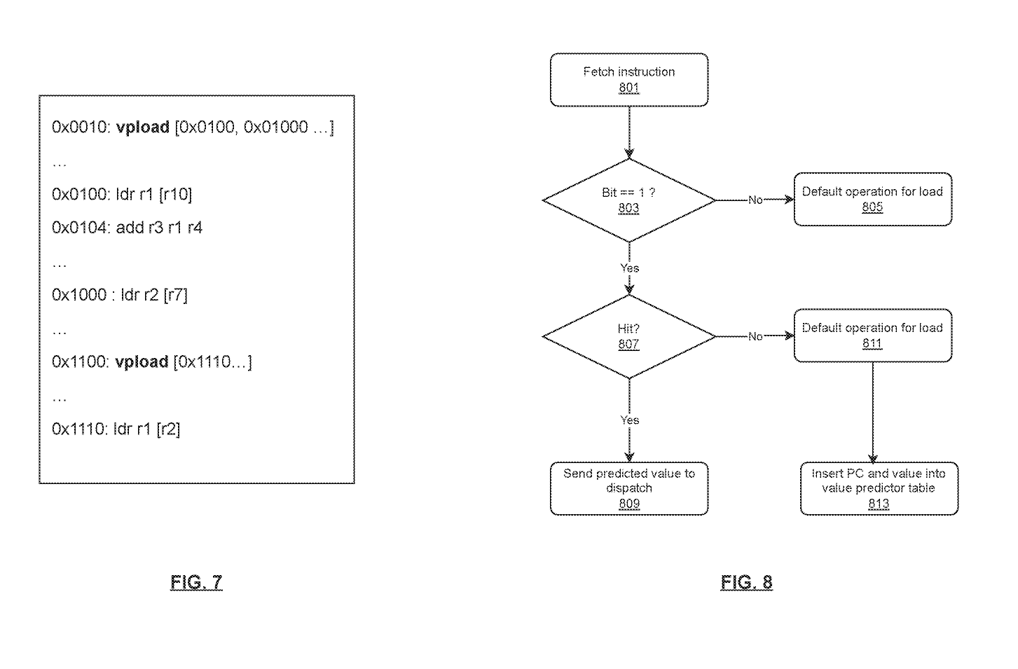

An exemplary executable with injected vpload instructions is shown in FIG. 7. In this example, LDR instructions at memory addresses 0x0100 and 0x1000 were identified as stable load instructions within a first interval of instructions, and LDR instruction at memory address 0x1110 is identified as a stable load instruction within a second interval of instructions. A first vpload instruction was injected at memory address 0x0010 to load the value predictor table with the PCs of LDR instructions 0x0100 and 0x1000. This vpload instruction was injected in a timely manner since it will be executed at memory address 0x0010, giving enough time for the value predictor table to be preloaded prior to the LDR instructions at 0x0100 and 0x1000 being executed, and prior to execution of the ADD instructions at 0x104 which is dependent on the LDR instruction at 0x0100. A second vpload instruction was injected at memory address 0x1100 to load the value predictor table with the PC of LDR instruction 0x1110. This vpload was injected in a timely manner since it will be executed at memory address 0x1100, giving enough time for the value predictor table to be preloaded prior to the LDR instruction at 0x1110 being executed.

In the illustrated example, the vpload instructions include only the PCs of stable load instructions. However, it is appreciated that in other configurations, the vpload instructions can also include predicted values associated with the stable load instructions.

In a third configuration of executable 411, hints are provided in the form of reserved bits in instructions of the executable code. Such reserved bits can allow distinguishing stable load instructions from other instructions. The hardware executing the instructions can use such bits to identify stable load instructions at runtime such that value prediction steps can be applied only to such instructions.

In this configuration, the software analysis 405 can involve analyzing an execution trace of the executable code operating on a workload to identify stable load instructions. For each of the identified stable load instructions, the reserved bit in that instruction can be set to 1 to indicate to hardware that this load instruction is likely to be stable. It is appreciated that the reserved bit is 0 by default for all other instructions. It is also appreciated that the reserved bit can be set to 1 only for a subset of identified stable load instructions, such as only a subset of identified stable load instructions that are determined to be the most profitable.

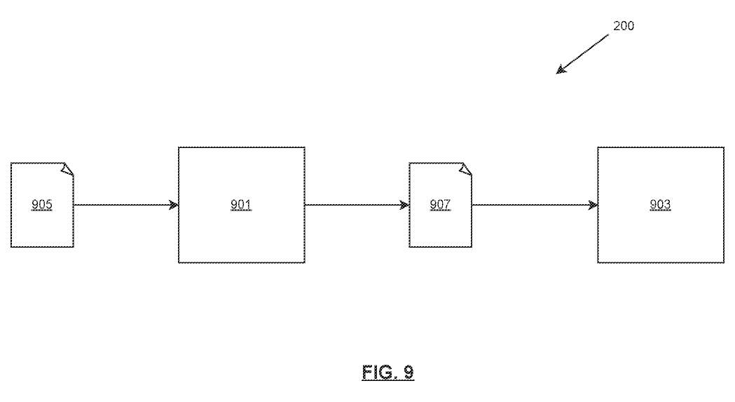

An exemplary method 800 for handling hints in the form of reserved bits at runtime on hardware is shown in FIG. 8. The method starts with an instruction entering the FETCH stage 801. If the fetched instruction is a load instruction, the reserved bit in the instruction can be verified 803 to determine whether the instruction is indicated as being a stable load instruction (i.e. if the reserved bit is set to 1). If the reserved bit does not indicate the instruction as being a stable load instruction, the instruction can proceed to normal execution without value prediction 805. If the reserved bit does indicate the instruction as being a stable load instruction, then value prediction can be carried out. In the illustrated embodiment, this involves querying the value predictor table 807 to determine if it contains an entry corresponding to the PC of the instruction and/or if a predicted value exists for that instruction. In the event of a hit, the hardware sends the predicted value to scheduling stage 809. Otherwise, the hardware proceeds with sending the instruction through the pipeline for full execution 811 and then writes back the instruction PC and resulted load value into the value predictor table for future use 813. Although not illustrated, it is appreciated that in other embodiments, further steps associated with value prediction can be carried out, for example as described above in connection with steps 507-515 of method 500.

As can be appreciated, an advantage of this configuration of the executable 411 is that no extra section for metadata on the executable is needed. The information on which loads are likely to be stable is encoded in the load instructions themselves. As such, there is no need to store this information in a separate section of the executable. However, it is appreciated that the design of the hardware executing will need to have unused bits available to allow for this configuration of executable to be used.

With reference FIG. 9, an exemplary computing environment 900 for performing the above-described software and hardware co-design for load value prediction is shown. The computing environment comprises a first processor 901 and a second processor 903. The first processor 901 is configured to receive executable code 905, and to inject hints into the executable code 905 to produce an executable comprising load value prediction hints 907. The second processor is configured to receive hint-injected executable 907, and to execute the instructions therein while performing value prediction based on the injected hints.

The first processor 901 can be one or more processors for performing functions as described in connection with method 400 described above. For example, the first processor 901 can comprise one or more processors for performing software profiling and one or more processors for separately injecting hints (e.g., via a compiler or binary optimizer), or can comprise one or more processors that perform both software profiling and hint injection. In an embodiment, the first processor can be configured to perform at least the steps of receiving executable code; processing the executable code to identify instructions having substantially stable load values; and injecting hints into the executable code to indicate the identified instructions to the second processor.

The second processor 905 can be one or more processors for executing code in the hint-injected executable 907 using load-value prediction, for example as described above in connection with method 500. The second processor 905 can, for example, be a high-performance processor on a user device, such as a smartphone. In an embodiment, the second processor can be configured at least to: fetch instructions from the memory into an instruction pipeline; determine whether hints in the executable code indicate the instructions as loading substantially stable values; and execute the instructions, wherein the instructions are executed using load value prediction based on whether the instructions are indicated as loading substantially stable values.

It is clear that a person skilled in the art can make various modifications and variations to this application without departing from the scope of this disclosure. This disclosure is intended to cover these modifications and variations of this application provided that they fall within the scope of protection defined by the following claims and their equivalent technologies.

What is claimed is:

1. A method for load value prediction comprising, at a first processor:
receiving executable code;
processing the executable code to identify instructions having substantially stable load values; and
injecting hints into the executable code to indicate the identified instructions to a second processor that executes the executable code.

2. The method according to claim 1, wherein the hints are configured to cause the second processor to preload a value predictor table with the identified instructions prior to executing the identified instructions.

3. The method according to claim 2, wherein processing the executable code comprises identifying instructions having substantially stable load values in predetermined intervals of instructions, and wherein the hints are configured to cause the second processor to preload the value predictor table with the identified instructions prior to executing the intervals of instructions.

4. The method according to claim 3, wherein processing the executable codes comprises, for each interval of instructions: identifying a trigger memory address associated with a beginning of the interval, and identifying instructions in the interval having substantially stable load values; and wherein the hints are configured to cause the second processor to, upon executing an instruction at the trigger memory address, load the instructions in the interval having substantially stable load values into the value predictor table.

5. The method according to claim 2, wherein preloading the value predictor table comprises loading memory addresses corresponding to the identified instructions as entries in the value predictor table.

6. The method according to claim 5, wherein preloading the value predictor table further comprises populating the entries in the value predictor table with predicted load values for the identified instructions.

7. The method according to claim 2, wherein injecting hints comprises embedding load value profile metadata into the executable code, further wherein the second processor is configured to regularly query the load value profile metadata to preload the value predictor table with the identified instructions prior to executing the identified instructions.

8. The method according to claim 2, wherein injecting hints comprises injecting instructions into the executable code that instruct the second processor to preload the value predictor table prior to executing the identified instructions.

9. The method according to claim 1, wherein injecting hints comprises setting reserved bits in the instructions of the executable code, the reserved bits distinguishing the instructions having substantially stable load values from instructions not having substantially stable load values.

10. The method according to claim 9, wherein the second processor is configured to verify the reserved bits when fetching instructions, and to perform load value prediction on fetched instructions only if the reserved bits indicate that the instructions have substantially stable load values.

11. The method according to claim 1, wherein identifying instructions having substantially stable load values comprises identifying instructions that load a constant value in a predetermined interval of instructions, or that load the constant value above a predetermined consistency threshold during the predetermined interval of instructions.

12. A non-transitory computer-readable medium having executable code stored thereon, the executable code comprising:
a plurality of instructions which, when executed by a processor, cause the processor to load values into memory; and
a plurality of hints identifying at least some of the plurality of instructions that cause the processor to load substantially stable values.

13. The non-transitory computer-readable medium according to claim 12, wherein the plurality of hints comprise load value profile metadata indicating memory addresses of instructions that cause the processor to load substantially stable values.

14. The non-transitory computer-readable medium according to claim 13, wherein the load profile metadata indicates predicted load values associated with the instructions that cause the processor to load substantially stable values.

15. The non-transitory computer-readable medium according to claim 13, wherein the load value profile metadata comprises a table having a plurality of entries, each entry corresponding to an interval in the plurality of instructions and comprising a list of memory addresses associated with instructions within the interval that cause the processor to load substantially stable values.

16. The non-transitory computer-readable medium according to claim 12, wherein the plurality of hints comprise instructions that cause the processor to preload a value predictor table prior to executing subsequent instructions that are included in the value predictor table.

17. The non-transitory computer-readable medium according to claim 12, wherein the plurality of hints comprise reserved bits in the plurality of instructions that distinguish instructions having substantially stable load values from instructions that do not have substantially stable load values.

18. A processor for executing executable code loaded in memory, the processor being configured to:
fetch instructions from the memory into an instruction pipeline;
determine whether hints in the executable code indicate the instructions as loading substantially stable values; and
execute the instructions, wherein the instructions are executed using load value prediction based on whether the instructions are indicated as loading substantially stable values.

19. The processor according to claim 18, wherein the processor is configured to determine whether the instructions are indicated as loading substantially stable values by querying a pre-populated value predictor table to determine whether entries for the instructions exist in the value predictor table.

20. The processor according to claim 18, wherein the processor is configured to determine whether the instructions are indicated as loading substantially stable values by verifying reserved bits associated with the instructions.
